(19) United States
(12) Patent Application Publication
(10) Pub. No.: US 2021/0188205 A1
(43) Pub. Date: Jun. 24, 2021

(54) VEHICLE VISION SYSTEM

(71) Applicant: ZF FRIEDRICHSHAFEN AG, Friedrichshafen (DE)

(72) Inventors: VENKATESWARA ADUSUMALLI, New Hudson, MI (US); ROBERT BERG, Ann Arbor, MI (US); SANTANU PANJA, Commerce Township, MI (US); JAMES OLDIGES, Farmington Hills, MI (US); SRIHARSHA YELURI, Farmington Hills, MI (US); RADHA SIVARAMAN, Troy, MI (US)

(21) Appl. No.: 16/720,161

(22) Filed: Dec. 19, 2019

(51) Int. Cl. B60R 21/015; G06K 9/00; G06K 9/62

(52) U.S. Cl. CPC B60R 21/01538; G06K 9/00362; B60R 21/01516; G06K 9/6267; G06K 9/00832

(57) ABSTRACT

A method for providing protection for an occupant of a vehicle includes acquiring at least one live image of the vehicle interior. An occupant is detected within the at least one live image. The detected occupant is classified based on the at least one live image. An operator of the vehicle is notified of the detected classification. At least one deployment characteristic of an airbag associated with the detected occupant is set based on the classification.

### TECHNICAL FIELD

The present invention relates generally to vehicle assist systems, and specifically to a vision system for helping to protect occupants of a vehicle.

### BACKGROUND

Current driver assistance systems (ADAS—advanced driver assistance system) offer a series of monitoring functions in vehicles. In particular, the ADAS can monitor the environment within the vehicle and notify the driver of the vehicle of conditions therein. To this end, the ADAS can capture images of the vehicle interior and digitally process the images to extract information. The vehicle can perform one or more functions in response to the extracted information.

### SUMMARY

In one example, a method for providing protection for an occupant of a vehicle includes acquiring at least one live image of the vehicle interior. An occupant is detected within the at least one live image. The detected occupant is classified based on the at least one live image. An operator of the vehicle is notified of the detected classification. At least one deployment characteristic of an airbag associated with the detected occupant is set based on the classification.

In another example, a method for providing protection for an occupant of a vehicle includes acquiring at least one live image of the vehicle interior. An occupant is detected within the at least one live image. An age and weight of the detected occupant is estimated. The detected occupant is classified based on the estimated age and weight. An operator of the vehicle is notified of the detected classification. Feedback from the operator is received in response to the notification. At least one deployment characteristic of an airbag associated with the detected occupant is set based on the classification and the feedback.

Other objects and advantages and a fuller understanding of the invention will be had from the following detailed description and the accompanying drawings.

### BRIEF DESCRIPTION OF THE DRAWINGS

FIG. 1A is a top view of a vehicle including an example vision system in accordance with the present invention.

FIG. 1B is a section view taken along line 1B-1B of the vehicle of FIG. 1A.

FIG. 2A is a schematic illustration of an ideally aligned image of the vehicle interior.

FIG. 2B is a schematic illustration of another example ideally aligned image.

FIG. 3 is a schematic illustration of a live image of the vehicle interior.

FIG. 4 is a comparison between the ideally aligned image and live image using generated keypoints.

FIG. 5 is a schematic illustration of a calibrated live image with an ideally aligned region of interest.

FIG. 6 is a schematic illustration of the live image with a calibrated region of interest.

FIG. 7 is a schematic illustration of consecutive live images taken by the vision system.

FIG. 8 is a schematic illustration of a confidence level used to evaluate the live images.

FIG. 9 is an enlarged view of a portion of the confidence level of FIG. 8.

FIG. 10 is a schematic illustration of a child and adult in front seats of the vehicle.

FIG. 11 is a schematic illustration of an elderly person and a teenager in front seats of the vehicle.

FIG. 12 is a schematic illustration of a controller connected to vehicle components.

FIG. 13 is a schematic illustration of the vehicle interior including occupant protection device.

### DETAILED DESCRIPTION

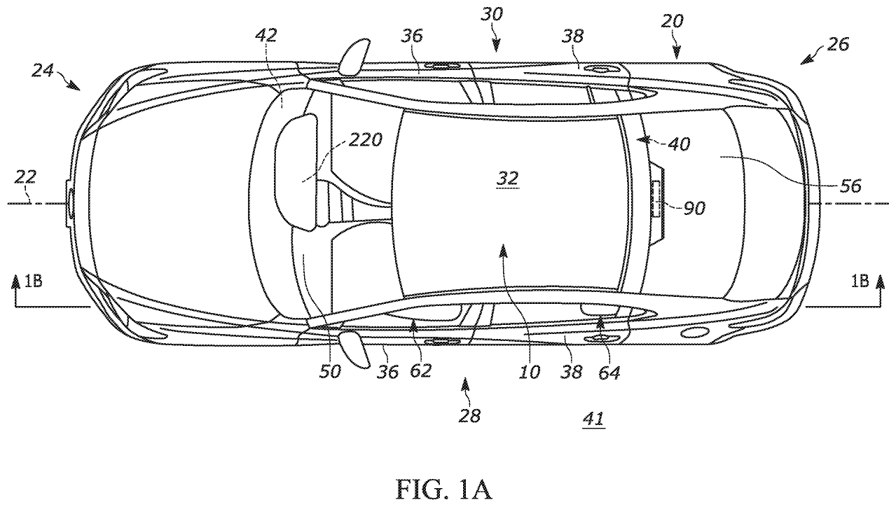

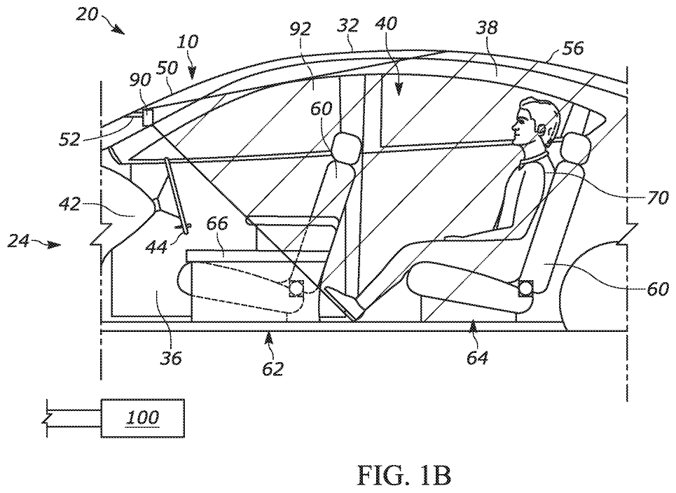

The present invention relates generally to vehicle assist systems, and specifically to a vision system for helping to protect occupants of a vehicle. FIGS. 1A-1B illustrate a vehicle 20 having an example vehicle assist system in the form of a vision system 10 for acquiring and processing images within the vehicle. The vehicle 20 extends along a centerline 22 from a first or front end 24 to a second or rear end 26. The vehicle 20 extends to a left side 28 and a right side 30 on opposite sides of the centerline 22. Front and rear doors 36, 38 are provided on both sides 28, 30. The vehicle 20 includes a roof 32 that cooperates with the front and rear doors 36, 38 on each side 28, 30 to define a passenger cabin or interior 40. An exterior of the vehicle 20 is indicated at 41.

The front end 24 of the vehicle 20 includes an instrument panel 42 facing the interior 40. A steering wheel 44 extends from the instrument panel 42. Alternatively, the steering wheel 44 can be omitted (not shown) if the vehicle 20 is an autonomous vehicle. Regardless, a windshield or windscreen 50 is located between the instrument panel 42 and the roof 32. A rear view mirror 52 is connected to the interior of the windshield 50. A rear window 56 at the rear end 26 of the vehicle 20 helps close the interior 40.

Seats 60 are positioned in the interior 40 for receiving one or more occupants 70. In one example, the seats 60 can be arranged in front and rear rows 62 and 64, respectively, oriented in a forward-facing manner. In an autonomous vehicle configuration (not shown), the front row 62 can be rearward facing. A seat belt 59 is associated with each seat 60 for helping to restrain the occupant 70 in the associated seat. A center console 66 is positioned between the seats 60 in the front row 62.

The vision system 10 includes at least one camera 90 positioned within the vehicle 20 for acquiring images of the interior 40. As shown, a camera 90 is connected to the rear view mirror 52, although other locations, e.g., the roof 32, rear window 56, etc., are contemplated. In any case, the camera 90 has a field of view 92 extending rearward through the interior 40 over a large percentage thereof, e.g., the space between the doors 36, 38 and from the windshield 50 to the rear window 56. The camera 90 produces signals indicative of the images taken and sends the signals to a controller 100. It will be appreciated that the camera 90 can alternatively be mounted on the vehicle 20 such that the field of view 92 extends over or includes the vehicle exterior 41. The controller 100, in turn, processes the signals for future use.

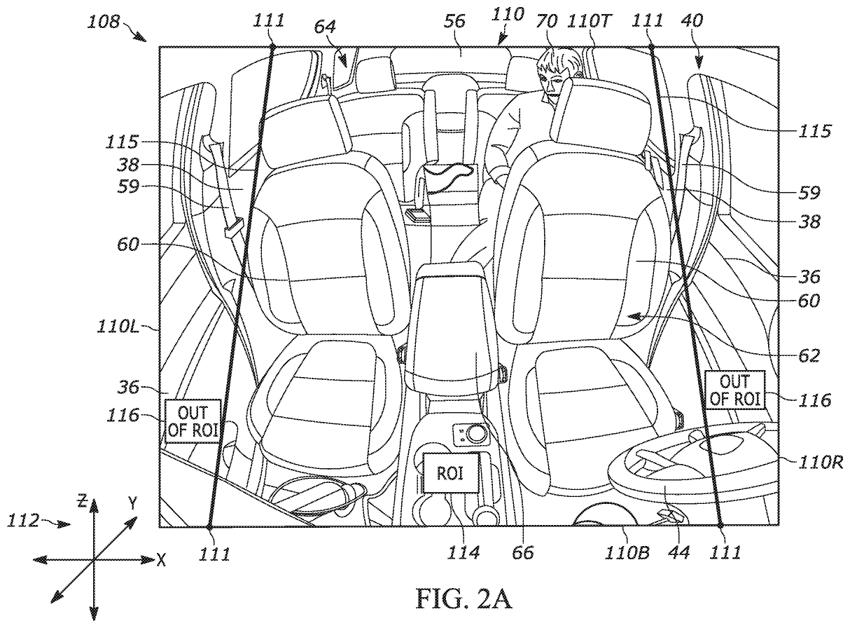

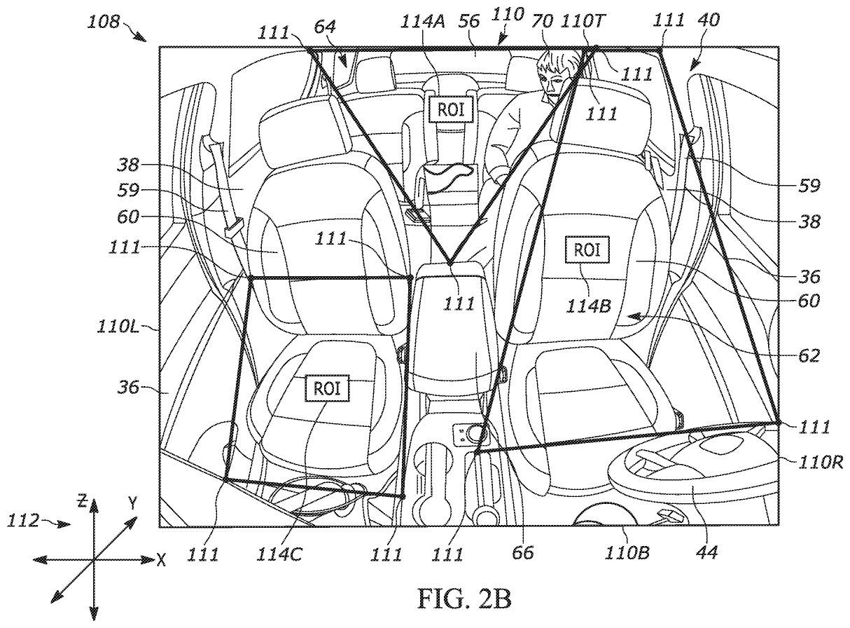

As shown in FIG. 2A, when the vehicle 20 is manufactured, a template or ideally aligned image 108 of the interior 40 is created for helping calibrate the camera 90 once the camera is installed and periodically thereafter. The ideally aligned image 108 reflects an ideal position of the camera 90 aligned with the interior 40 in a prescribed manner to produce a desired field of view 92. To this end, for each make and model of vehicle 20, the camera 90 is positioned such that its live images, i.e., images taken during vehicle use, most closely match the ideally aligned, desired orientation in the interior 40 including a desired location, depth, and boundary. The ideally aligned image 108 captures portions of the interior 40 where it is desirable to monitor/detect objects, e.g., seats 60, occupants 70, pets or personal effects, during operation of the vehicle 20.

The ideally aligned image 108 is defined by a boundary 110. The boundary 110 has a top boundary 110T, a bottom boundary 110B, and a pair of side boundaries 110L, 110R. That said, the boundary 110 shown is rectangular although other shapes for the boundary, e.g., triangular, circular, etc. are contemplated. Since the camera 90 faces rearward in the vehicle 20, the side boundary 110L is on the left side of the image 108 but the right side 30 of the vehicle 20. Similarly, the side boundary 110R on the right side of the image 108 is on the left side 28 of the vehicle 20. The ideally aligned image 108 is overlaid with a global coordinate system 112 having x-, y-, and z-axes.

The controller 100 can divide the ideally aligned image 108 into one or more regions of interest 114 (abbreviated “ROI” in the figures) and/or one or more regions of disinterest 116 (indicated at “out of ROI” in the figures). In the example shown, boundary lines 115 demarcate the region of interest 114 in the middle from the regions of disinterest 116 on either side thereof. The boundary lines 115 extend between bounding points 111 that, in this example, intersect the boundary 110. The region of interest 114 lies between the boundaries 110T, 110B, 115. The left (as viewed in FIG. 2) region of disinterest 116 lies between the boundaries 110T, 110B, 110L, 115. The right region of disinterest 116 lies between the boundaries 110T, 110B, 110R, 115.

In the example shown in FIG. 2A, the region of interest 114 can be the area including the rows 62, 64 of seats 60. The region of interest 114 can coincide with areas of the interior 40 where it is logical that a particular object or objects would reside. For example, it is logical for occupants 70 to be positioned in the seats 60 in either row 62, 64 and, thus, the region of interest 114 shown extends generally to the lateral extent of the rows. In other words, the region of interest 114 shown is specifically sized and shaped for occupants 70—an occupant-specific region of interest as it were.

It will be appreciated that different objects of interest, e.g., pets, laptop, etc., can have a specifically sized and shaped region of interest that pre-defines where it is logical for that particular object to be located in the vehicle 20. These different regions of interest have predetermined, known locations within the ideally aligned image 108. The different regions of interest can overlap one another depending on the objects of interest associated with each region of interest.

With this in mind, FIG. 2B illustrates different regions of interest in the ideally aligned image 108 for different objects of interest, namely, the region of interest 114a is for a pet in the rear row 64, the region of interest 114b is for an occupant in the driver's seat 60, and the region of interest 114c is a for a laptop. Each region of interest 114a-114c is bound between associated bounding points 111. In each case, the region of interest 114-114c is the inverse of the region(s) of disinterest 116 such that collectively the regions form the entire ideally aligned image 108. In other words, everywhere in the ideally aligned image 108 not bound by the region of interest 114-114c is considered the region(s) of disinterest 116.

Returning to the example shown in FIG. 2A, the regions of disinterest 116 are the areas laterally outside the rows 62, 64 and adjacent the doors 36, 38. The regions of disinterest 116 coincide with areas of the interior 40 where it is illogical for the objects (here occupants 70) to reside. For example, it is illogical that an occupant 70 would be positioned on the interior of the roof 32.

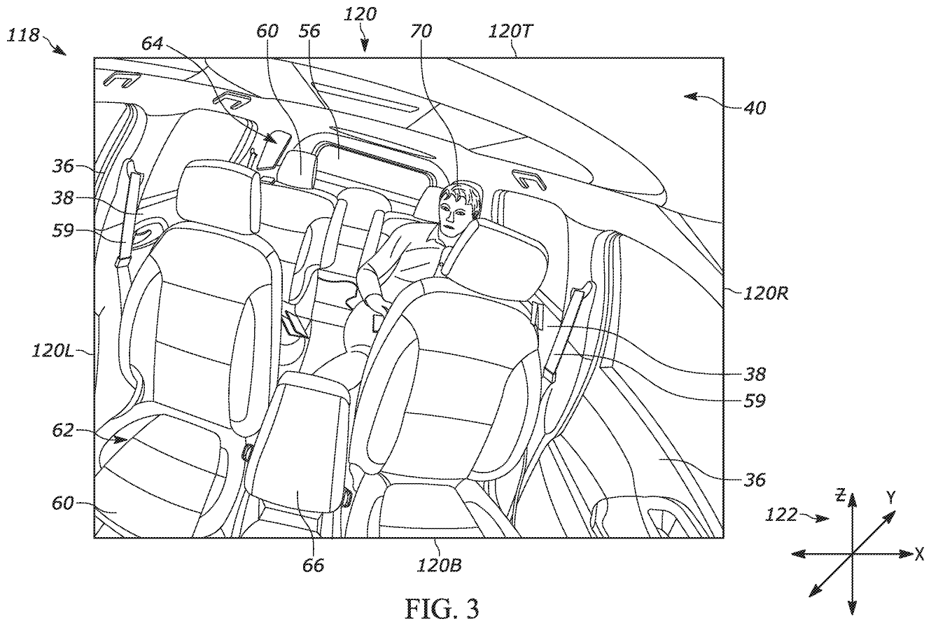

During vehicle 20 operation, the camera 90 acquires images of the interior 40 and sends signals to the controller 100 indicative of the images. The controller 100, in response to the received signals, performs one or more operations to the image and then detects objects of interest in the interior 40. The images taken during vehicle 20 operation are referred to herein as “live images”. An example live image 118 taken is shown in FIG. 3.

The live image 118 shown is defined by a boundary 120. The boundary 120 includes a top boundary 120T, a bottom boundary 120B, and a pair of side boundaries 120L, 120R. Since the camera 90 faces rearward in the vehicle 20, the side boundary 120L is on the left side of the live image 118 but the right side 30 of the vehicle 20. Similarly, the side boundary 120R on the right side of the live image 118 is on the left side 28 of the vehicle 20.

The live image 118 is overlaid or associated with a local coordinate system 122 having x-, y-, and z-axes from the perspective of the camera 90. That said, the live image 118 may indicate a deviation in position/orientation in the camera 90 compared to the position/orientation of the camera that generated the ideally aligned image 108 for several reasons. First, the camera 90 can be installed improperly or otherwise in an orientation that captures a field of view 92 deviating from the field of view generated by the camera taking the ideally aligned image 108. Second, the camera 90 position can be affected after installation due to vibration from, for example, road conditions and/or impacts to the rear view mirror 52. In any case, the coordinate systems 112, 122 may not be identical and, thus, it is desirable to calibrate the camera 90 to account for any differences in orientation between the position of the camera capturing the live images 118 and the ideal position of the camera capturing the ideally aligned image 108.

In one example, the controller 100 uses one or more image matching techniques, such as Oriented FAST and rotated BRIEF (ORB) feature detection, to generate keypoints in each image 108, 118. The controller 100 then generates a homography matrix from matching keypoint pairs and uses that homography matrix, along with known intrinsic camera 90 properties, to identify camera position/orientation deviations across eight degrees of freedom to help the controller 100 calibrate the camera. This allows the vision system to ultimately better detect objects within the live images 118 and make decisions in response thereto.

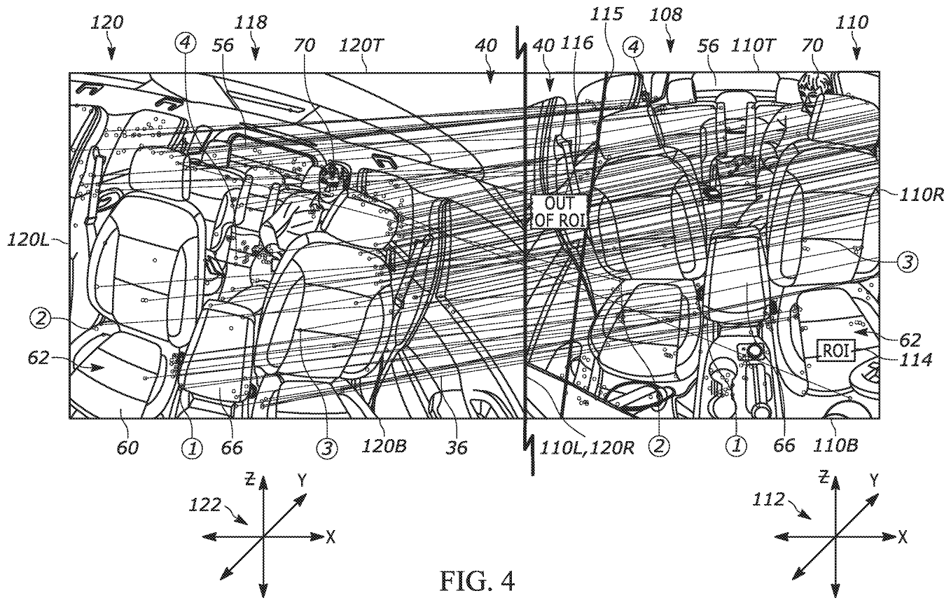

One example implementation of this process is illustrated in FIG. 4. The ideally aligned image 108 and the live image 118 are placed adjacent one another for illustrative purposes. The controller 100 identifies keypoints—illustrated keypoints are indicated as \textcircled{1}, \textcircled{2}, \textcircled{3}, \textcircled{4}—within each image 108, 118. The keypoints are distinct locations in the images 108, 118 that are attempted to be matched with one another and correspond with the same exact point/location/spot in each image. The features can be, for example, corners, stitch lines, etc. Although only four keypoints are specifically identified it will be appreciated that the vision system 10 can rely on hundreds or thousands of keypoints.

In any case, the keypoints are identified and their locations mapped between image 108, 118. The controller 100 calculates the homography matrix based on the keypoint matches in the live image 118 against the ideally aligned image 108. With additional information of the intrinsic camera properties, the homography matrix is then decomposed to identify any translations (x, y, and z axis), rotations (yaw, pitch, and roll), and sheer and scale of the camera 90 capturing the live image 118 relative to the ideal camera capturing the ideally aligned image 108. The decomposition of the homography matrix therefore quantifies the misalignment between the camera 90 capturing the live image 118 and the ideal camera capturing the ideally aligned image 108 across eight degrees of freedom.

A misalignment threshold range can be associated with each degree of freedom. In one instance, the threshold range can be used to identify which live image 118 degree of freedom deviations are negligible and which are deemed large enough to warrant physical correction of the camera 90 position and/or orientation. In other words, deviations in one or more particular degrees of freedom between the images 108, 118 may be small enough to warrant being ignored—no correction of that degree of freedom occurs. The threshold range can be symmetric or asymmetric for each degree of freedom.

If, for example, the threshold range for rotation about the x-axis was +/−0.05°, a calculated x-axis rotation deviation in the live image 118 from the ideally aligned image 108 within the threshold range would not be taken into account in physically adjusting the camera 90. On the other hand, rotation deviations about the x-axis outside the corresponding threshold range would constitute a severe misalignment and require recalibration or physical repositioning of the camera 90. The threshold ranges therefore act as a pass/fail filter for deviations in each degree of freedom.

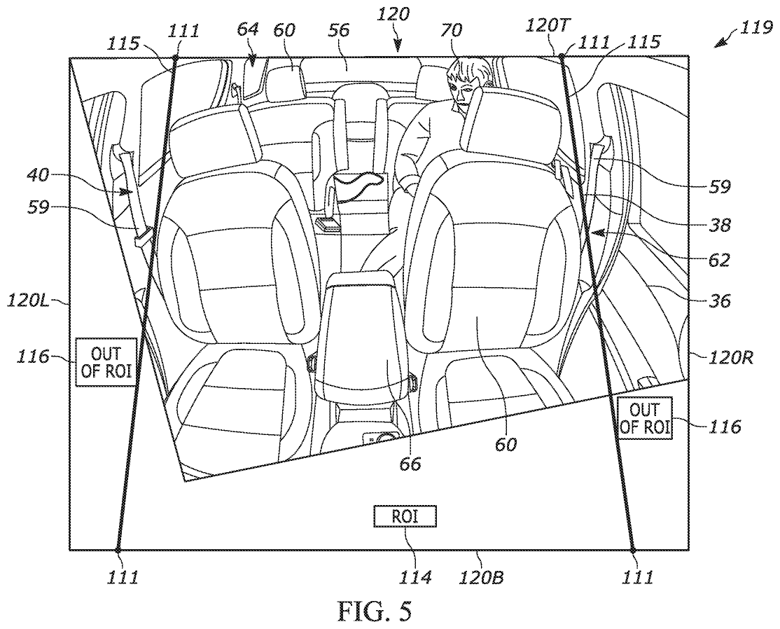

The homography matrix information can be stored in the controller 100 and used to calibrate any live image 118 taken by the camera 90, thereby allowing the vision system 10 to better react to said live images, e.g., better ascertain changes in the interior 40. To this end, the vision system 10 can use the homography matrix to transform the entire live image 118 and produce a calibrated or adjusted live image 119 shown in FIG. 5. When this occurs, the calibrated live image 119 can be rotated or skewed relative to the boundary 120 of the live image 118. The region of interest 114—via the bounding points 111—is then projected onto the calibrated live image 119. In other words, the un-calibrated region of interest 114 is projected onto the calibrated live image 119. This transformation of the live image 118, however, can involve extensive calculations by the controller 100.

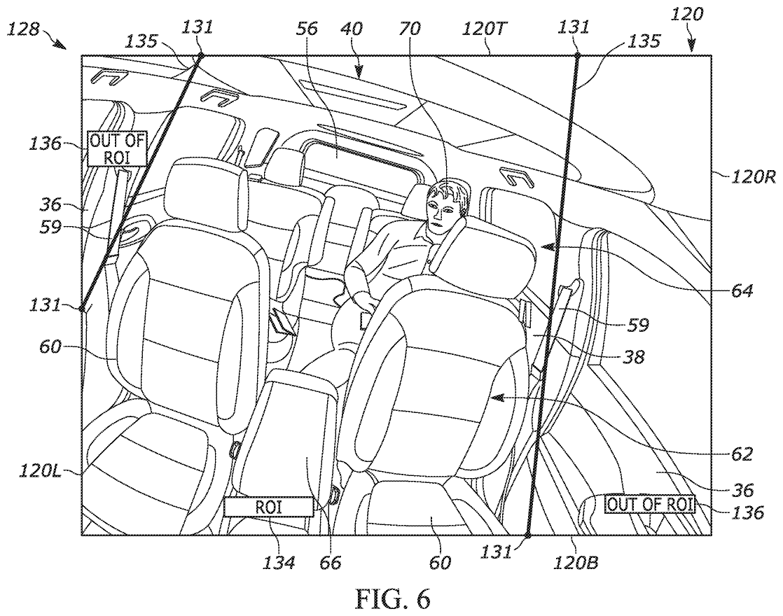

That said, the controller 100 can alternatively transform or calibrate only the region of interest 114 and project the calibrated region of interest 134 onto the un-calibrated live image 118 to form a calibrated image 128 shown in FIG. 6. In other words, the region of interest 114 can be transformed via the translation, rotation, and/or sheer/scale data stored in the homography matrix and projected or mapped onto the untransformed live image 118 to form the calibrated image 128.

More specifically, the bounding points 111 of the region of interest 114 are calibrated with transformations using the generated homography matrix to produce corresponding bounding points 131 in the calibrated image 128. It will be appreciated, however, that one or more of the bounding points 131 could be located outside the boundary 120 when projected onto the live image 118, in which case the intersection of the lines connecting the bounding points with the boundary 120 help to define the calibrated region of interest 134 (not shown). Regardless, the newly calibrated region of interest 134 aligns on the live image 118 (in the calibrated image 128) as the original region of interest 114 aligns on the ideally aligned image 108. This calibration in effect fixes the region of interest 114 such that image transformations don't need to be applied to the entire live images 118, thereby reducing processing time and power required.

To this end, calibrating the handful of bounding points 111 defining the region of interest 114 using the homography matrix is significantly easier, quicker, and more efficient than transforming or calibrating the entire live image 118 as was performed in FIG. 5. The region of interest 114 calibration ensures that any misalignment in the camera 90 from the ideal position will have minimal, if any, adverse effect on the accuracy in which the vision system 10 detects objects in the interior 40. The vision system 10 can perform the region of interest 114 calibration—each time generating a new homography matrix based on a new live image—at predetermined time intervals or occurrences, e.g., startup of the vehicle 20 or at five second intervals.

The calibrated region of interest 134 can be used to detect objects within the interior 40. The controller 100 analyzes the calibrated image 128 or calibrated region of interest 134 and determines what, if any, objects are located therein. In the example shown, the controller 100 detects occupants 70 within the calibrated region of interest 134. It will be appreciated, however, that the controller 100 can calibrate any alternative or additional regions of interest 114a-114c to form the associated calibrated region of interest and detect the particular object of interest therein (not shown).

The controller 100, when analyzing the calibrated image 128, may detect objects that intersect or cross outside the calibrated region of interest 134 and are therefore present both inside and out of the calibrated region of interest. When this occurs, the controller 100 can rely on a threshold percentage that determines whether the detected object is ignored. More specifically, the controller 100 can acknowledge or “pass” a detected object having at least, for example, 75% overlap with the calibrated region of interest 134. Consequently, a detected object having less than the threshold percentage overlap with the calibrated region of interest 134 will be ignored or “fail”. Only detected objects that meet this criterion would be taken into consideration for further processing or action.

The vision system 10 can perform one or more operations in response to detecting and/or identifying objects within the calibrated live image 128. This can include, but is not limited to, deploying one or more airbags based on where occupant(s) are located in the interior 40.

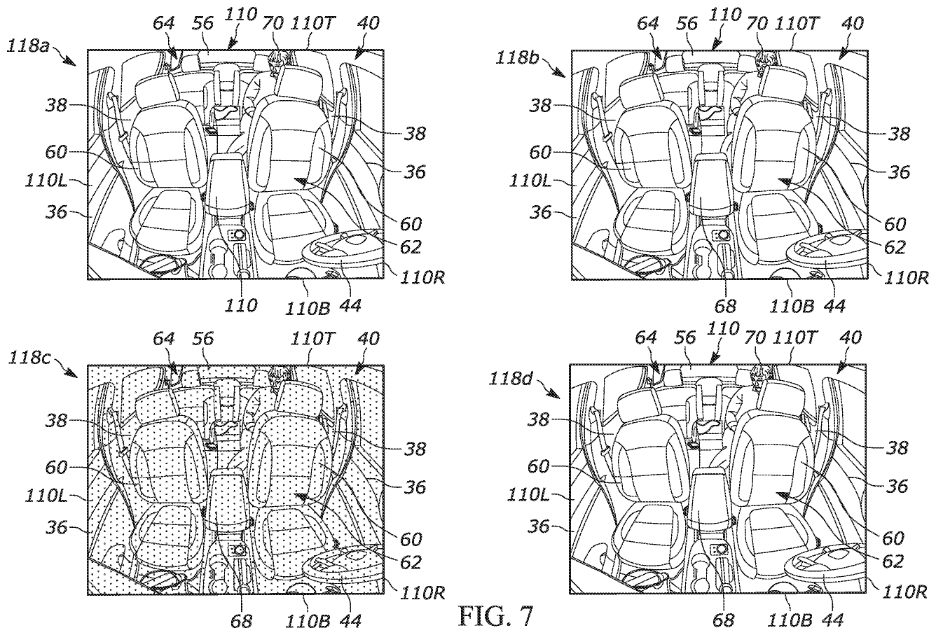

Referring to FIGS. 7-9, the vision system 10 includes additional safeguards, including a confidence level in the form of a counter, for helping ensure that objects are accurately detected within the live images 118. The confidence level can be used in combination with the aforementioned calibration or separately therefrom. During operation of the vehicle 20, the camera 90 takes multiple live images 118 (see FIG. 7) in rapid succession, e.g., multiple images per second. Each live image 118 in succession is given an index, e.g., first, second, third, . . . up to the n^{th} image and a corresponding suffix “a”, “b”, “c” . . . “n” for clarity. Consequently, the first live image is indicated at 118a in FIG. 7. The second live image is indicated at 118b. The third live image is indicated at 118c. The fourth live image is indicated at 118d. Although only four live images 118a-118d are shown it will be appreciated that the camera 90 can take more or fewer live images. Regardless, the controller 100 performs object detection in each live image 118.

With this in mind, the controller 100 evaluates the first live image 118a and uses image inference to determine what object(s)—in this example an occupant 70 in the rear row 64—is located within the first live image. The image inference software is configured such that an object won't be indicated as detected without at least a predetermined confidence level, e.g., at least 70% confidence an object is in the image.

It will be appreciated that this detection can occur following calibrating the first live image 118a (and subsequent live images) as described above or without calibration. In other words, object detection can occur in each live image 118 or specifically in the calibrated region of interest 134 projected onto the live image 118. The discussion that follows focuses on detecting the object/occupant 70 in the live images 118 without first calibrating the live images and without using a region of interest.

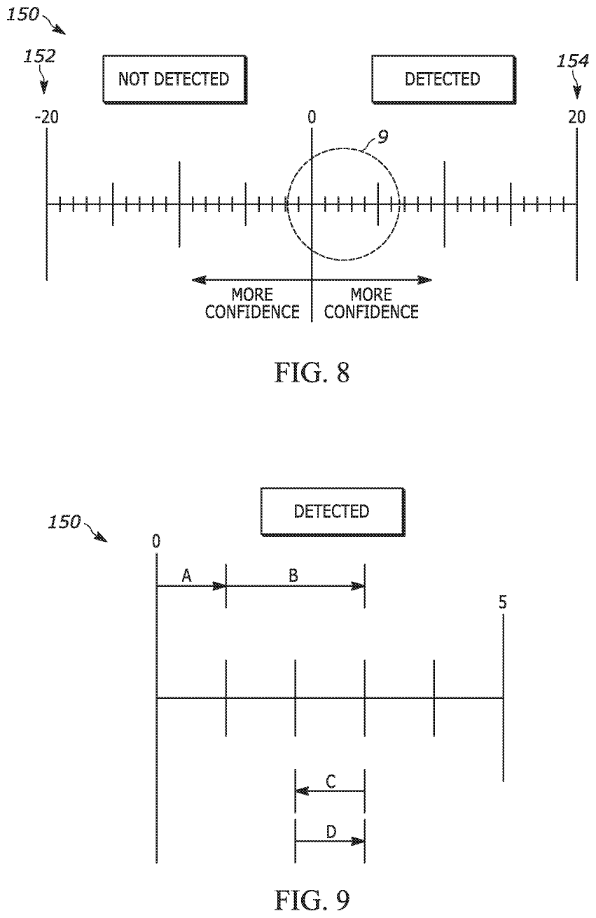

When the controller 100 detects one or more objects in a live image 118, a unique identification number and a confidence level 150 (see FIG. 8) in the are associated with or assigned to each detected object. Although multiple objects can be detected, in the example shown in FIGS. 7-9 only a single object—in this case the occupant 70—is detected and therefore only the single confidence level 150 associated therewith is shown and described for brevity. The confidence level 150 helps to assess the reliability of the object detection.

The confidence level 150 has a range between first and second values 152, 154, e.g., a range from −20 to 20. The first value 152 can act as a minimum value of the counter 150. The second value 154 can act as a maximum value of the counter 150. A confidence level 150 value of 0 indicates that no live images 118 have been evaluated or no determination can be made about the actual existence or lack thereof of the detected object in the live images 118. A positive value for the confidence level 150 indicates it is more likely than not that the detected object is actually present in the live images 118. A negative value for the confidence level 150 indicates it is more likely than not that the detected object is not actually present in the live images 118.

Furthermore, as the confidence level 150 decreases from a value of 0 towards the first value 152, the confidence that the detected object is not actually present in the live images 118 (a “false” indication) increases. On the other hand, as the confidence level 150 increases from 0 towards the second value 154, the confidence that the detected object is actually present in the live images 118 (a “true” indication) increases.

Before the first live image 118a is evaluated the confidence level 150 has a value of 0 (see also FIG. 9). If the controller 100 detects the occupant 70 within the first live image 118a the value of the confidence level 150 increases to 1. This increase is shown schematically by the arrow A in FIG. 9. Alternatively, detecting an object in the first live image 118a can keep the confidence level 150 at a value of 0 but trigger or initiate the multi-image evaluation process.

For each subsequent live image 118b-118d, the controller 100 detects whether the occupant 70 is present or not present. The confidence level 150 will increase in value (move closer to the second value 154) when the controller 100 detects the occupant 70 in each of the live images 118b-118d. The confidence level 150 will decrease in value (move closer to the first value 152) each time the controller 100 does not detect the occupant 70 in one of the live images 118b-118d.

The amount the confidence level 150 increases or decreases for each successive live image can be the same. For example, if the occupant 70 is detected in five consecutive live images 118, the confidence level 150 can increase as follows: 0, 1, 2, 3, 4, 5. Alternatively, the confidence level 150 can increase in a non-linear manner as the consecutive number of live images in which the occupant 70 is detected increases. In this instance, the confidence level 150 can increase as follows: 0, 1, 3, 6, 10, 15 after each live image 118 detection of the occupant 70. In other words, the reliability or confidence in the object detection assessment can increase rapidly as the object is detected in more consecutive images.

Similarly, if the occupant 70 is not detected in five consecutive live images 118, the confidence level 150 can decrease as follows: 0, −1, −2, −3, −4, −5. Alternatively, if the occupant 70 is not detected in five consecutive live images 118, the confidence level 150 can decrease in a non-linear manner as follows: 0, −1, −3, −6, −10, −15. In other words, the reliability or confidence in the object detection assessment can decrease rapidly as the object is not detected in more consecutive images. In all cases, the confidence level 150 adjusts, i.e., increases or decreases, as each successive live image 118 is evaluated for object detection. It will be appreciated that this process is repeated for each confidence level 150 associated with each detected object and, thus, each detected object will undergo the same object detection evaluation.

It will also be appreciated that once the counter 150 reaches the minimum value 152 any subsequent non-detection will not change the value of the counter from the minimum value. Similarly, once the counter 150 reaches the maximum value 154 any subsequent detection will not change the value of the counter from the maximum value.

With the example shown, after detecting the occupant 70 in the first live image 118a, the controller then detects the occupant in the second live image 118b, does not detect the occupant in the third live image 118c, and detects the occupant in the fourth live image 118d. The lack of detection in the third live image 118c can be attributed to lighting changes, rapid motion of the occupant 70, etc. As shown, the third live image 118c is darkened by lighting conditions in/around the vehicle 20, rendering the controller 100 unable to detect the occupant 70. That said, the confidence level 150 increases in value by 2 in the manner indicated by the arrow B in response to the occupant 70 detection in the second live image 118b.

The confidence level 150 then decreases in value by 1 in the manner indicated by the arrow C in response to no detection of the occupant 70 in the third live image 118c. The confidence level 150 then increases in value by 1 in the manner indicated by the arrow D in response to the occupant 70 detection in the fourth live image 118d. The final confidence level 150 has a value of 3 following evaluation of all the live images 118a-118d for object detection.

The final value of the confidence level 150 between the first and second values 152, 154 can indicate when the controller 100 ascertains the detected occupant 70 is in fact present and the degree of confidence in that determination. The final value of the confidence level 150 can also indicate when the controller 100 ascertains the detected occupant 70 is not in fact present and the degree of confidence in that determination. The controller 100 can be configured to make the final determination of whether a detected occupant 70 is actually present or not after evaluating a predetermined number of consecutive live images 118 (in this case four) or after a predetermined time frame, e.g., seconds or minutes, of acquiring live images.

The positive value of the confidence level 150 after examining the four live images 118a-118d indicates it is more likely than not that the occupant 70 is in fact present in the vehicle 20. The value of the final confidence level 150 indicates the assessment is less confident than a final value nearer the second value 154 but more confident than a final value closer to 0. The controller 100 can be configured to associate specific percentages or values to each final confidence level 150 value or range of values between and including the values 152, 154.

The controller 100 can be configured to enable, disable, actuate and/or deactivate one or more vehicle functions in response to the value of the final confidence level 150. This can include, for example, controlling vehicle airbags, seatbelt pre-tensioners, door locks, emergency braking, HVAC, etc. It will be appreciated that different vehicle functions may be associated with different final confidence level 150 values. For instance, vehicle functions associated with occupant safety may require a relatively higher final confidence level 150 value to initiate actuation than a vehicle function unrelated to occupant safety. To this end, object detection evaluations with a final confidence level 150 value of 0 or below can be completely discarded or ignored in some situations.

Evaluation of the live images 118 can be conducted multiple times or periodically during operation of the vehicle 20. The evaluation can be performed within the vehicle interior 40 when the field of view 92 of the camera 90 faces inward or around the vehicle exterior 41 when the field of view faces outward. In each case, the controller 100 examines multiple live images 118 individually for object detection and makes a final determination with an associated confidence value that the detected object is or is not actually present in the live images.

The vision system shown and described herein is advantageous in that it provides increased reliability in object detection in and around the vehicle. When multiple images of the same field of view within a short timeframe are taken, the quality of one or more images can be affected by, for example, lighting conditions, shadows, objects passing in front of and obstructing the camera and/or motion blurring. Consequently, current cameras may produce false positive and/or false negative detections of objects in the field of view. This false information can have adverse effects in downstream applications that rely on object detection.

By analyzing a series of consecutive live images individually to determine a cumulative confidence score, the vision system of the present invention helps alleviate the aforementioned deficiencies that may exist in a single frame. The vision system shown and described herein therefore helps reduce false positives and false negatives in object detection.

That said, the controller 100 can not only detect an object within the vehicle 20 but classify the detected object. At a first stage of classification, the controller 100 determines whether the detected object is a human/occupant or an animal/pet. In the former case, a second, classification is made of the detected occupant that can be based on age, height, weight or any combination thereof.

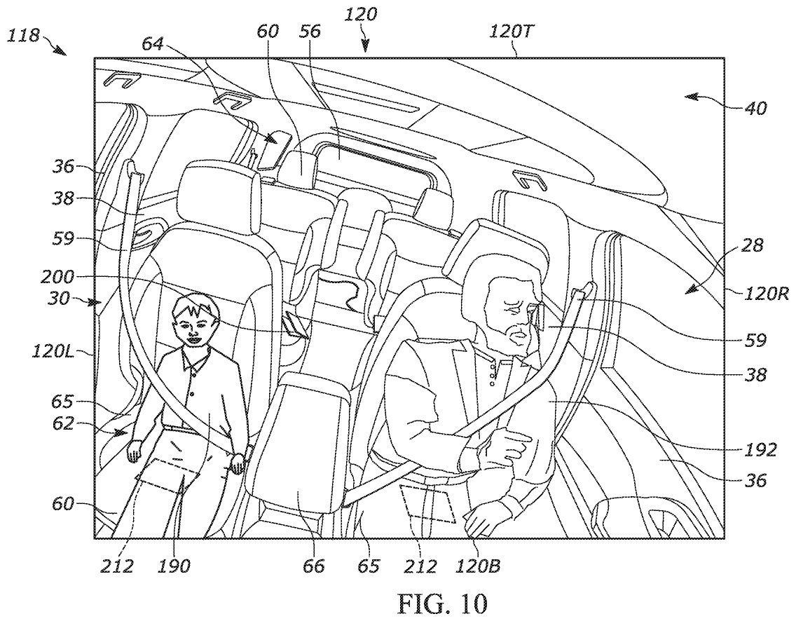

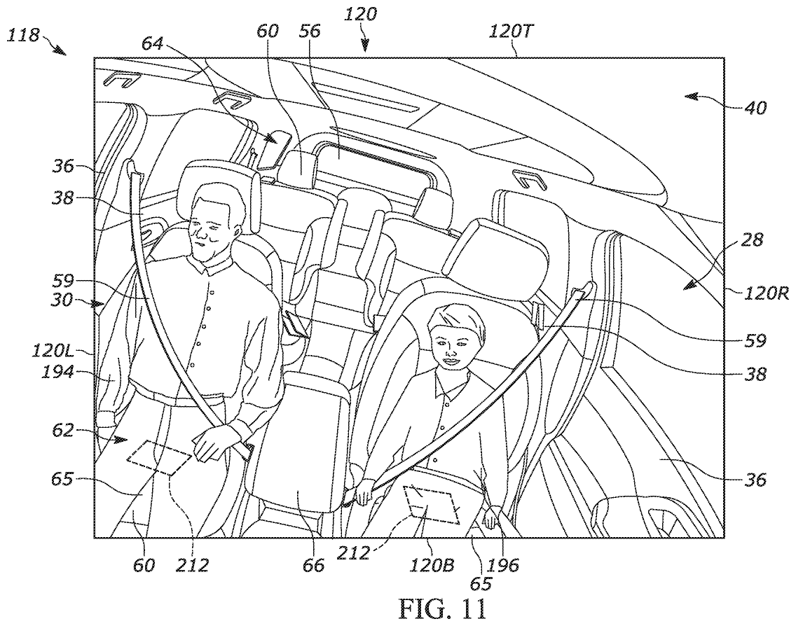

In an example shown in FIG. 10, the controller 100 detects and identifies a child 190 and an adult 192 in the vehicle interior 40, e.g., in the seats 60 in the front row 62. In the example shown in FIG. 11, the controller 100 detects and identifies an elderly person 194 and a teenager 196 in the seats 60 in the front row 62. It will be appreciated that any of the child 190, adult 192, elderly person 194 or teenager 196 could also be located in the rear row 64 (not shown).

In each instance, the occupant detection can be made with or without calibrating the live image 118 or region of interest 114 associated with the ideally aligned image 108. The detection can also be performed with or without utilizing the confidence level/counter 150. In any case, the process described occurs after the controller 100 determines an occupant is in the vehicle 20.

Regardless, the controller 110, in response to receiving the signals from the camera 90, uses an artificial intelligence (AI) model, image inference and/or pattern recognition software to estimate the age of each detected occupant. The AI model can be prepared and trained under supervised learning for this application. Other features of the detected occupants, e.g., sitting height and weight, can also be estimated with an AI model, image inference and/or pattern recognition software.

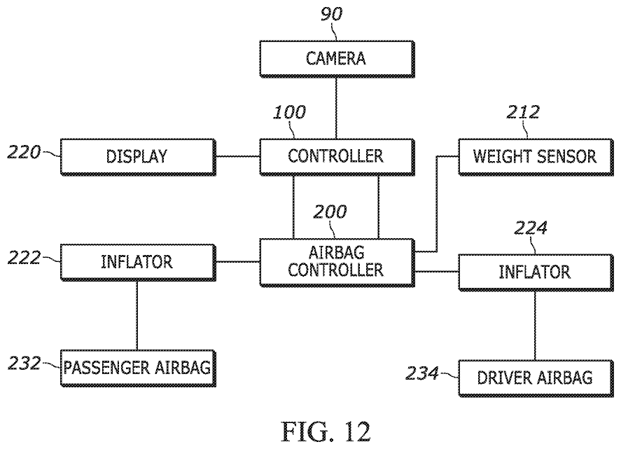

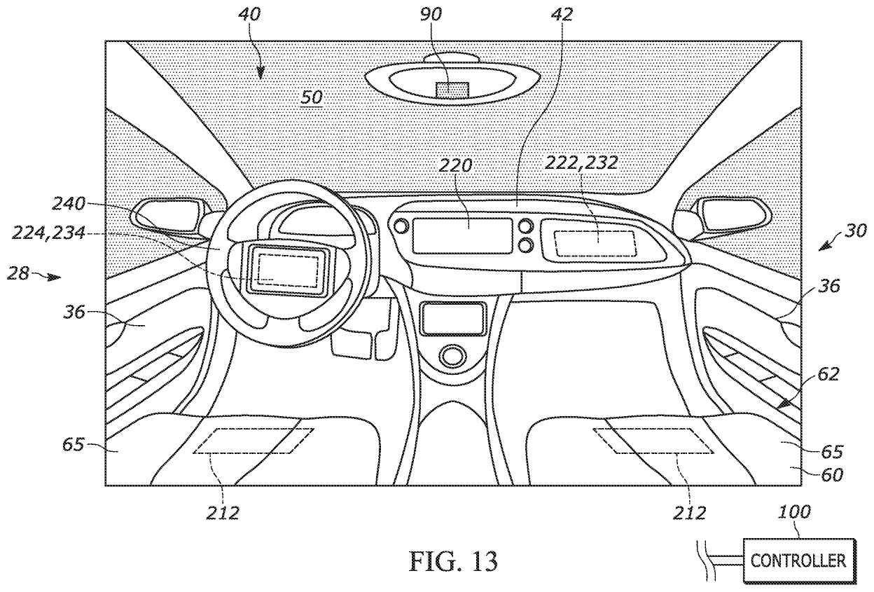

Referring to FIGS. 12-13, the controller 100 is connected to or includes an integral airbag controller 200. One or more weight sensors 212 are positioned in a seat base 65 of each seat 60 in the vehicle 20 and connected to the airbag controller 200. The weight sensors 212 detect the weight of any object on the seat base 65 and send signals indicative of the detected weight to the controller 200. As a result, the vision system 10 can rely on both the camera 90 and the weight sensors 212 to help estimate the weight of each detected occupant.

The controller 100 can include look-up tables or the like that correlate sitting height and weight (or ranges thereof) with particular age classifications. That said, the controller 100 can utilize the estimated age in combination with the estimated sitting height and weight to make an age-based classification determination for each detected occupant with high reliability.

The age-based classifications can be based on estimating that the detected occupant has an age within a prescribed range, e.g., under 12 years old for a child 190, between 12 and 19 years old for a teenager 196, between 20 and 60 years old for an adult 192, and over 60 years old for an elderly person 194. Other age ranges, however, are contemplated for each identification.

The controller 100 is also connected to a display 220 in the vehicle interior 40 and visible to the occupants 70. In one example, the display 220 is located on the instrument panel 42 (see FIG. 13).

The airbag controller 200 is connected to one or more inflators fluidly connected to associated airbags. In the example shown, a first inflator 222 is fluidly connected to a passenger side frontal airbag 232 mounted in the instrument panel 42. Another inflator 224 is fluidly connected to a driver side frontal airbag 234 mounted in the steering wheel 240.

The inflators 222, 224 can be single stage or multi-stage inflators capable of delivering inflation fluid to the associated airbags 232, 234 at one or more rates and/or pressures. The airbags 232, 234 can include passive or active adaptive features, such as tethers, vents, tear stitching, ramps, etc. Consequently, the deployment characteristics of each airbag 232, 234, e.g., size, shape, contour, stiffness, speed, pressure, and/or direction, can be controlled by the inflators 222, 224 and/or by operating the adaptive features. The controller 100, being connected to the inflators 222, 224 and the airbags 232, 234 (more specifically the adaptive features) through the airbag controller 200 can affect the deployment characteristics of each airbag.

With this in mind, each occupant classification can have a particular set of airbag deployment characteristics associated therewith that depend on the type of airbag and location in the vehicle 20. In other words, the airbag controller 200 can be equipped with a table or the like that correlates each type of occupant classification with particular airbag deployment characteristics. These correlations can also take into account the type of airbag, e.g., front air bag, side curtain, knee bolster, etc., and the location in the vehicle, e.g., front row or rear row. Each combination of deployment characteristics can have a corresponding set of inflator 222, 224 and/or airbag 232, 234 commands or controls associated therewith. The airbag controller 200 can associate each distinct set of commands/controls with a distinct “mode”.

The airbag controller 200 can be connected to additional inflators associated with additional airbags (not shown) positioned throughout the vehicle 20, e.g., side curtain airbags along the left or right sides 28, 30, floor-mounted airbags, roof-mounted airbags and/or seat-mounted airbags. The airbag controller 200 and, thus, the controller 100 can affect or control the deployment characteristics of these additional airbags.

With this in mind, once the controller 100 identifies and classifies the occupant(s) a signal is sent to the display 220 notifying the operator of the vehicle 20 where occupants have been detected in the vehicle, e.g., front or rear rows 62, 64, and the classification of each detected occupant. This includes information related to classification of the operator themselves.

For example, the controller 100 can send a notification to the display 220 when the controller detects a child 190 (FIG. 10) in the front row 62 on the right/passenger side 30 and an adult 192 on the left/driver side 28. The operator of the vehicle 20—in this case the adult 192—can provide feedback, e.g., touch the display 220 or voice command, confirming whether the occupant classification is accurate or inaccurate. If the operator indicates the child 190 classification is accurate, the controller 100 directs the airbag controller 200 to set the deployment characteristics of the passenger airbag 232 to an “infant” or “child” mode corresponding with an airbag deployment providing relatively reduced impact forces should a vehicle crash occur. These reduced impact forces can be forces commensurate with child airbag safety standards.

On the other hand, if the operator indicates the child 190 classification is inaccurate, e.g., the occupant classified as a child is actually an adult, the controller 100 directs the airbag controller 200 to set the deployment characteristics of the passenger airbag 232 to an “adult” mode corresponding with an airbag deployment providing standard impact forces should a vehicle crash occur. These impact forces can be forces commensurate with adult airbag safety standards.

The remaining age-related classifications can have associated airbag deployment characteristics that are the same as the “adult mode” or “child mode” or different therefrom. In particular, the controller 100 can direct the airbag controller 200 to set the deployment characteristics to an “intermediate mode” in response to classifying the detected occupant as either the elderly person 194 or the teenager 196 shown in FIG. 11. This “intermediate mode” can correspond with airbag deployment characteristics providing reaction forces valued between the “child mode” and the “adult mode” reaction forces.

It will be appreciated that although the height, weight, and age of the detected occupant are used to collectively determine an age-based classification of the occupant, the controller could alternatively classify the occupant differently, e.g., based on weight, and use the remaining data gathered to adjust the deployment characteristics of the airbag. In other words, the controller can initially determine weight-based deployment characteristics and subsequently adjust those deployment characteristics based on the remaining height and age information.

In each scenario, the controller receives signals from the camera and weight sensor(s), classifies detected occupants in the vehicle based on those signals, and notifies the vehicle operator of the classifications. In response, the operator provides feedback by confirming or correcting each classification. The controller then sets the deployment characteristics or “mode” of each airbag accordingly.

The vision system of the present invention is advantageous in that provides increased reliably in classifying occupants of a vehicle and thereafter tailoring occupant protection measures, e.g., airbag deployment, in response to those classifications. Furthermore, by allowing the vehicle operator to provide feedback to those classifications prior to setting the particular protection measures, the operator can act as a check on the classification determinations made and thereby help ensure the proper protection measures are implemented.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method for providing protection for an occupant of a vehicle, comprising:
acquiring at least one live image of the vehicle interior;
detecting an occupant within the at least one live image;
classifying the detected occupant based on the at least one live image;
notifying an operator of the vehicle of the detected classification; and
setting at least one deployment characteristic of an airbag associated with the detected occupant based on the classification.

2. The method of claim 1, wherein the classification is based on an estimated age of the detected occupant in the at least one live image using an artificial intelligence model.

3. The method of claim 1, wherein the classification is based on an estimated sitting height of the detected occupant.

4. The method of claim 1 further comprising acquiring data indicative of a weight of the detected occupant and classifying the detected occupant based on the weight.

5. The method of claim 4, wherein the weight data is an estimated weight of the detected occupant in the at least one live image using an artificial intelligence model.

6. The method of claim 5, wherein the weight data is further based on signals acquired by a weight sensor provided in a seat occupied by the detected occupant.

7. The method of claim 1, wherein the occupant is classified as one of a teenager and an elderly person.

8. The method of claim 1 further comprising:
receiving feedback from the operator in response to the notification; and
setting the at least one deployment characteristic of the airbag based on the feedback.

9. The method of claim 8, wherein the feedback comprises confirming the classification.

10. The method of claim 8, wherein the feedback comprises changing the classification.

11. The method of claim 1, wherein the step of setting at least one deployment characteristic comprises setting an inflation rate of the airbag associated with the detected occupant.

12. The method of claim 1, wherein the step of setting at least one deployment characteristic comprises setting an inflation pressure of the airbag associated with the detected occupant.

13. A method for providing protection for an occupant of a vehicle, comprising:
acquiring at least one live image of the vehicle interior;
detecting an occupant within the at least one live image;
estimating an age and weight of the detected occupant;
classifying the detected occupant based on the estimated age and weight;
notifying an operator of the vehicle of the detected classification;
receiving feedback from the operator in response to the notification; and
setting at least one deployment characteristic of an airbag associated with the detected occupant based on the classification and the feedback.

14. The method of claim 13, wherein the age is estimated using an artificial intelligence model with the at least one live image.

15. The method of claim 13, wherein the classification is based on an estimated sitting height of the occupant.

16. The method of claim 13, wherein the weight is estimated using an artificial intelligence model with the at least one live image.

17. The method of claim 13, wherein the feedback comprises confirming the classification.

18. The method of claim 13, wherein the feedback comprises changing the classification.

19. The method of claim 13, wherein the step of setting at least one deployment characteristic comprises setting an inflation rate of the airbag associated with the detected occupant.

20. The method of claim 13, wherein the step of setting at least one deployment characteristic comprises setting an inflation pressure of the airbag associated with the detected occupant.
